(19) United States
(12) Patent Application Publication
(10) Pub. No.: US 2011/0267018 A1
(43) Pub. Date: Nov. 3, 2011

(54) AC COUPLED HYSTERETIC PWM CONTROLLER

(76) Inventor: Hai Tao, Sunnyvale, CA (US)

(21) Appl. No.: 13/095,211

(22) Filed: Apr. 27, 2011

Related U.S. Application Data
(60) Provisional application No. 61/330,252, filed on Apr. 30, 2010.

(51) Int. Cl. G05F 1/10

(52) U.S. Cl. 323/282

(57) ABSTRACT

This document discusses, among other things, an apparatus and method for a hysteretic controller for an inductor based power converter. The hysteretic controller can include a coupling circuit configured to provide feedback information to a hysteretic comparator, the feedback information including a DC component of a feedback voltage and an AC component of the signal indicative of current flow through the inductor, wherein the feedback voltage is a scaled representation of load voltage.

### CLAIM OF PRIORITY

This application claims the benefit of priority under 35 U.S.C. §119(e) to Tao, U.S. Provisional Patent Application Ser. No. 61/330,252, entitled “AC COUPLED HYSTERETIC PWM CONTROLLER,” filed on Apr. 30, 2010 (Attorney Docket No. 2921.051PRV), which is hereby incorporated by reference herein in its entirety.

### BACKGROUND

Power converters are essential for many modern electronic devices. Among other capabilities, power converters can adjust voltage level downward (buck converter) or adjust voltage level upward (boost converter). Power converters may also convert alternating current (AC) power to direct current (DC) power, or vice versa. Power converters are typically implemented using one or more switching devices, such as transistors, which are turned on and off to deliver power to the output of the converter.

Klein, U.S. Pat. No. 7,457,140, entitled, “POWER CONVERTER WITH HYSTERETIC CONTROL”, refers to a method for hysteretic control of a DC-to DC power converter, and is incorporated by reference herein in its entirety.

### OVERVIEW

This document discusses, among other things, an apparatus and method for receiving an input signal at a hysteric controller, such as a hysteretic controller for a power converter, and providing an output signal, including providing a reference signal to a hysteretic comparator of the hysteric controller and providing a feedback signal to the comparator, wherein the feedback signal includes an AC component of a switch signal and a DC component of the output signal.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a power converter with a hysteretic controller.

FIG. 2 illustrates generally an example of a power converter with a hysteretic controller according to an example of the present subject matter.

### DETAILED DESCRIPTION

In certain power converters applications, the load current may vary significantly (e.g., over several orders of magnitude), in which case it can be desirable to have rapid response in the regulation or control of the converters. In an example, certain power converters can use pulse-width modulation (PWM) to control the on-time of a switch connected to a supply (e.g., an unregulated DC input). In a hysteretic power converter, a ramp waveform, for example, derived from current flow of the converter, is maintained between two threshold values to control a switching circuit, or power train module, of the converter. In an example, a hysteretic regulator can turn on a switching device of a power converter when Vₒᵤₜ is below a first threshold voltage (e.g., 5V), and can turn off the switching device of the converter when Vₒᵤₜ is above a second threshold voltage.

In certain examples, a hysteretic control circuit provides control information to control a first switch and a second switch. In an example, the first switch can connect a first voltage, such as input voltage, to an inductor. In this example, a second switch can connect a second voltage, such as a ground to the inductor. In this example, the first and second switches can be controlled by the hysteretic control circuit, and can be turned on in a mutually-exclusive manner. In an example, the first and second switches can toggle between conducting and non-conducting states, such as to keep an instantaneous output voltage within a specified range. The specified range can be proportional to a hysteresis “window” around a desired output voltage, the window including an upper (e.g., peak) threshold and a lower (e.g., valley) threshold.

In certain examples, the output voltage can increase when the first switch is conducting, such as when the inductor current is positive and flowing towards a load resistance, or decrease, when the second switch is conducting. The increase or decrease in output voltage can be periodic, such as when the regulator circuit has stabilized and is driving the load. In certain examples, the variation in output voltage is caused by the regulator, and the regulator circuit is thus called a “ripple regulator” or “bang-bang” regulator.

In an example, many previous PWM and hysteretic controllers cannot go into or out of 100% duty cycle conveniently, nor do they deal with an external Vₒᵤₜ feedback resistive divider easily (e.g., requiring an error-amplifier to act as an integrator). Further, many previous hysteretic controllers require a reference voltage of the main comparator to be the same as the output voltage of the power converter, adding more design constraints to the main comparator and reference generator.

The present inventors have recognized, among other things, that a coupling circuit can be added to a hysteretic controller, for example, to allow the main comparator input voltage to be different than the final output voltage of the controller. Further, in certain examples, a coupling circuit can allow a hysteretic controller to use a voltage divider feedback structure without requiring an integrator circuit. In an example, the coupling resistance can be significantly higher than the resistance of the feedback network to decouple the values of a feedback network (e.g., an external feedback resistor divider) from the loop parameters of the hysteretic controller. In an example, a coupling circuit can enable hysteretic controllers to go into and out of 100% duty cycle conveniently, and can enable use of the external Vₒᵤₜ feedback resistive divider without requiring an error amplifier, and without requiring a minimum load to prevent the error amplifier from drifting away. In addition, a hysteretic controller incorporating a coupling circuit as described below can maintain robust load-transient response.

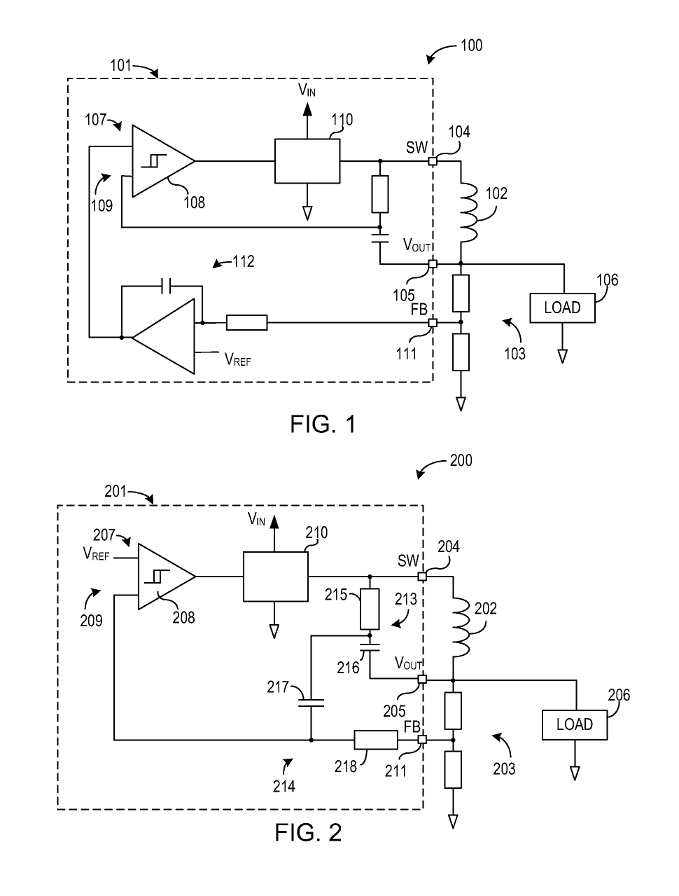

FIG. 1 illustrates generally a power converter 100 with a hysteretic controller 101. The power converter 100 can include the hysteretic controller 101, an inductor 102 and an optional feedback network 103. The inductor 102 can be coupled to a switch output (SW) 104 and the current through the inductor 102 can be controlled to maintain a desired load voltage (VOUT) at an output 105 of the power converter 100. The output 105 of the power converter 100 can supply power to a load 106. In some examples, setpoint information, such as a voltage reference equal to the desired voltage output, is received at a first input 107 of a hysteretic comparator 108 and the output voltage and a ramp voltage, indicative of the current through the inductor 102, can be received at a second input 109 of the hysteretic comparator 108. The hysteretic comparator 108 can provide control information, such as a modulation signal, to a power train module 110 to maintain the output voltage V_{OUT} within a window defined by the hysteretic comparator 108 and the associated components. In an example, a feedback network 103 can provide feedback information, such as a scaled representation of the load voltage V_{OUT}, at a feedback node (FB) 111. The scaled representation of the load voltage can be compared to a scaled setpoint V_{REF} to provide a setpoint to the first input 107 of the hysteretic comparator 108. Using a feedback network 103, such as a voltage divider, to provide the scaled representation of the output voltage requires an integrator circuit 112 to provide a proper reference for the hysteretic comparator 108. The integrator circuit 112 provides a suitable setpoint to the hysteretic comparator 108 that can pull the output voltage V_{OUT} to the desired voltage level represented by V_{REF}. However, in certain examples, the use of an integrator circuit 112 limits the minimum load that can be coupled to the power converter 100. In such examples, a minimum load is maintained to prevent the integrator circuit output from drifting and disrupting the stability of the hysteretic controller 101. In an example, the power train module 110 can include first and second switches connected in an half-bridge arrangement at the switch output, SW, to control the current flow through the inductor 102 and, ultimately, to supply the desired output voltage and current to the load 106.

FIG. 2 illustrates generally an example of a power converter 200 with a hysteretic controller 201 according to an example of the present subject matter. The power converter 200 can include the hysteretic controller 201, an inductor 202 and a feedback network 203. The inductor 202 can be coupled to a switch output (SW) 204 and current through the inductor 202 can be controlled to maintain a desired load voltage (V_{OUT}) at a voltage output 205 of the power converter 200. The hysteretic controller 201 can include a hysteretic comparator 208, a ramp circuit 213, and a coupling circuit 214. The ramp circuit 213 can include a ramp resistor 215 and a ramp capacitor 216. The ramp resistor 215 and the ramp capacitor 216 can provide a ramp signal by summing the output voltage V_{OUT} with a voltage indicative of the current through the inductor 202. The coupling circuit can include a coupling capacitor 217 and a coupling resistor 218. In an example, an AC component of the ramp signal can be fed back to the hysteretic comparator 208 through the coupling capacitor 217 of the coupling circuit 214. The feedback network 203 can include a voltage divider coupled to the voltage output 205. The voltage divider can provide a scaled representation of the load voltage V_{OUT} at a feedback node 211. A scaled DC component of the voltage output 205 can be summed to the AC component of the ramp signal using the coupling resistor 218 of the coupling circuit 214. The hysteretic comparator 208 can receive the summed feedback signal from the coupling circuit 214 at a second input 209. The hysteretic comparator can compare the summed feedback signal from the coupling circuit 214 to a voltage reference V_{REF}, received at a first input 207, to maintain a desired load voltage output V_{OUT}. In an example, the hysteretic comparator 208 can provide a switch signal to a power train circuit 210 to control the inductor current. In an example, the power train circuit 210 can include first and second switches connected in an half-bridge arrangement at the switch output, SW, 204 to control the current flow through the inductor 202 and to supply the desired output voltage and current to the load 206.

In certain examples, the coupling circuit 214 of the hysteretic controller 201 can provide design flexibility not available using the architecture illustrated in FIG. 1. For example, the coupling circuit 214 can allow the use of a voltage divider feedback network 203 such that a setpoint voltage VREF can be lower than the desired output voltage V_{OUT}, thus, lower voltage components can be used to provide the setpoint voltage, V_{REF}. In an example, the coupling circuit 214 can eliminate an integrator circuit when using a feedback network 203, such as a voltage divider, to provide a scaled representation of the output voltage V_{OUT}. Eliminating the integrator circuit can save component area and reduce device cost. In some examples, eliminating the integrator circuit can reduce device size and power consumption. In certain examples, the coupling circuit 214 can allow the power converter to transition in to and out of 100% duty cycle of the power train without compensation. for example, when the input voltage is at or near the desired output voltage. In such an example, the power train can couple input voltage to the inductor such that the inductor simulates a short circuit and power transfers from the input supply node to the output supply node very efficiently. As the input begins to deviate from the desired output, the hysteretic controller can seamlessly resume switching the power train to maintain the desired output voltage. In contrast, additional control would be needed to compensate for the tendency of the integrator circuit of FIG. 1 to saturate if the hysteretic controller where to go to 100% duty cycle for an extended interval. In addition, elimination of the integrator circuit means the power converter of FIG. 2 can operate without a minimum load requirement.

Another benefit of the coupling circuit is the flexibility in selecting the voltage divider components. For example, a coupling circuit having a coupling capacitance of 11 pF and a coupling resistance of 500 kOhms was monitored with two significantly different voltage divider networks. In a first example, the voltage divider resistances were 2.5 kOhms and 8.65 kOhms. In a second example, the voltage divider resistances were 70 kOhms and 242 kOhms, significantly high than the resistances of the first example. The resulting plots of the load voltage, inductor current and load current were substantially the same even when the load current underwent significant step increases and significant step decreases. Thus, the coupling circuit allows significant flexibility in selecting the size of the voltage divider components.

Certain examples can be beneficial in applications having a load voltage very close to the supply voltage, having a high load current and/or where a voltage divider feedback is desired. USB buck regulators and DC-DC buck regulator requiring good load transient response are example applications for which a hysteretic controller having a coupling circuit as described above can be especially useful.

In certain examples, an integrated circuit can include a hysteretic controller. In some examples, an integrated circuit hysteretic controller can be coupled to an external inductor. In some examples, an integrated circuit hysteretic controller can couple to an external feedback network to allow flexibility in using the controller for different applications. In some examples, an integrated circuit hysteretic controller can couple to an external power train module.

### Additional Notes

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, although the examples above have been described relating to MOSFET devices, one or more examples can be applicable to bipolar devices. In other examples, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A hysteretic power converter system comprising:
a switch circuit configured to couple a supply voltage to an inductor to provide a load voltage;
a hysteretic comparator configured to receive setpoint information at a first input and feedback information at a second input and to provide control information to the switch circuit;
a ramp circuit configured to provide a signal indicative of current flow through the inductor; and
a coupling circuit configured to provide the feedback information to the second input of the hysteretic comparator, the feedback information including a DC component of a feedback voltage and an AC component of the signal indicative of current flow through the inductor, wherein the feedback voltage is a scaled representation of the load voltage.

2. The system of claim 1, wherein the ramp circuit includes a ramp resistor coupled to an output of the switch circuit and a ramp capacitor configured to receive the load voltage, wherein a ramp circuit node, common to both the ramp resistor and the ramp capacitor, is configured to provide the signal indicative of current flow through the inductor.

3. The system of claim 1, wherein the coupling circuit includes a coupling resistor configured to receive the feedback voltage and a coupling capacitor configured to receive the signal indicative of current flow through the inductor.

4. The system of claim 3, wherein the coupling circuit includes a summing node common to the coupling resistor and the coupling capacitor, the summing node coupled to the second input of the hysteretic comparator.

5. The system of claim 1 including an inductor coupled to an output of the switching circuit.

6. The system of claim 1, including a voltage divider configured to receive the load voltage and to provide the feedback voltage.

7. The system of claim 1, including an integrated circuit including the hysteretic comparator, the ramp circuit, and the coupling circuit.

8. The system of claim 7, including an external voltage divider coupled to the integrated circuit, the external voltage divider configured to receive the load voltage and to provide the feedback voltage.

9. The system of claim 7, wherein the integrated circuit includes a voltage divider, the voltage divider configured to receive the load voltage and to provide the feedback voltage.

10. The system of claim 7, wherein the integrated circuit includes the switching circuit.

11. The system of claim 1, wherein the inductor includes an external inductor, and wherein the switch circuit is configured to couple the supply voltage to the external inductor.

12. The system of claim 1, wherein the system includes the inductor.

13. A method for operating a hysteretic power converter, the method comprising:
receiving setpoint information at a first input of a hysteretic comparator;
receiving feedback information at a second input of the hysteretic comparator;
providing control information to a switching circuit from an output of the hysteretic comparator;
coupling a supply voltage to an inductor to provide a load voltage using the switching circuit;
providing a signal indicative of current flow through the inductor using a ramp circuit;
providing the feedback information to the second input of the hysteretic comparator using a coupling circuit; and
wherein the providing the feedback information includes:
receiving a feedback voltage at the coupling circuit, wherein the feedback voltage includes a scaled representation of the load voltage;
providing a DC component of the feedback voltage; and
providing an AC component of the signal indicative of current flow through the inductor.

14. The method of claim 13, wherein the providing the signal indicative of the current flow includes receiving an output of the switching circuit at a ramp resistor of the ramp circuit.

15. The method of claim 14, wherein the providing the signal indicative of the current flow includes receiving the load voltage at a ramp capacitor of the ramp circuit.

16. The method of claim 15, wherein the providing the signal indicative of the current flow includes providing the signal indicative of current flow through the inductor at a ramp circuit node between the ramp resistor and the ramp capacitor.

17. The method of claim 13, wherein the receiving a feedback voltage includes receiving the feedback voltage from a voltage divider.

18. The method of claim 13, wherein the receiving a feedback voltage includes receiving the feedback voltage at a coupling resistor of the coupling circuit.

19. The method of claim 18, wherein the providing an AC component of the signal indicative of current flow through the inductor includes receiving the signal indicative of current flow through the inductor at a coupling capacitor of the coupling circuit.

20. The method of claim 19, wherein providing the feedback information includes providing the feedback information from a feedback node between the coupling resistor and the coupling capacitor.
